(19) United States
(12) Patent Application Publication
(10) Pub. No.: US 2026/0268264 A1
(43) Pub. Date: Sep. 10, 2026

(54) METHOD, APPARATUS, AND RECORDING MEDIUM FOR ASSESSING ACADEMIC DEPARTMENT APTITUDE

(71) Applicant: Aptimizer Co.,Ltd., Seoul (KR)

(72) Inventors: Hun Seok OH, Gwangmyeong-si (KR); Jang Han LYU, Seoul (KR); Ye Been KIM, Seoul (KR); Soo Kyeong KIM, Seoul (KR)

(21) Appl. No.: 19/561,391

(22) Filed: Mar. 9, 2026

(30) Foreign Application Priority Data
Mar. 10, 2025 (KR) 10-2025-0030567

(51) Int. Cl. G06Q 10/0639

(52) U.S. Cl. CPC G06Q 10/06398

(57) ABSTRACT

Provided is a method for assessing academic department aptitude performed by an electronic device. The method includes generating a department-specific persona language model by fine-tuning an artificial intelligence language model with department-specific profile data, generating department-specific standard response data for test questions using the department-specific persona language model, presenting a portion of the test questions to a terminal and receiving a response to the portion from the terminal, estimating, based on the received response, a response to test questions not presented to the terminal, and providing an academic department recommendation result based on the received response and the estimated response.

### CROSS-REFERENCE TO RELATED APPLICATION

This application is based on and claims the benefit of priority to Korean Patent Application No. 10-2025-0030567, filed Mar. 10, 2025, the aforementioned priority application being hereby incorporated by reference in its entirety.

### TECHNICAL FIELD

The present disclosure relates to a method, apparatus, and recording medium for assessing academic department aptitude, and more particularly, to a method, apparatus, and recording medium for recommending a suitable academic department to a user, such as a student or a member of the general public, based on responses to test questions.

### BACKGROUND

In a rapidly changing society, selecting a career path that matches an individual's aptitude and abilities is very important. For example, students preparing for university often struggle to choose a suitable academic department. If a student enters a department that does not match their aptitude, they often have difficulty sustaining their academic life or face challenges in finding a job later. To address these difficulties, various methods for assessing academic department aptitude have been developed, but conventional assessment methods have several limitations.

First, conventional academic aptitude assessments are often limited to analyzing interests or personality types, lacking a strong connection with the actual studies of a department. For example, even if an individual has a high interest in a specific department, it may not align with the academic skills or way of thinking required by that department. This can lead to students struggling to adapt to actual department life or result in lower academic achievement.

Furthermore, paper-based tests with a fixed set of questions have several limitations. The limited number of test questions may not sufficiently reflect an individual's characteristics. Alternatively, when a respondent must answer many questions within a limited time, they may choose impulsive answers without fully considering their thoughts. This degrades the accuracy of the assessment results and becomes a factor that prevents a proper understanding of the individual's characteristics.

Moreover, interpreting the assessment results often requires expert assistance, and there is frequently a lack of feedback on the results. The results are often provided merely as scores or grades, making it difficult for the respondent to specifically identify their strengths and weaknesses. Additionally, a lack of expert interpretation or supplementary information on the results can leave students feeling uncertain about how to utilize them.

To overcome these limitations, new methods for assessing academic department aptitude using artificial intelligence technology are being researched. Artificial intelligence has the potential to more accurately identify an individual's characteristics and provide customized information by analyzing and learning from vast amounts of data.

### SUMMARY

The technical problem of the present disclosure is conceived from such points, and an object of the present disclosure is to solve the following problems.

Conventional academic aptitude assessments had a problem in that the number of test questions is limited, so they cannot guarantee the reliability of the results, or, conversely, they are composed of a vast number of questions, amounting to hundreds, which places an excessive burden on the test-taker and makes the test time excessively long. This can lower the test-taker's concentration, thereby degrading the accuracy of the assessment, and may cause an aversion to the assessment.

Conventional academic aptitude assessments were conducted in a manner of presenting the same questions to all test-takers. In this case, because the questions are limited, it is difficult to include specific questions that can capture the diversity of individual learning experiences, interests, aptitudes, and the like, and thus, by failing to consider individual differences, there has been a limitation in providing test-taker customized results. Therefore, it was difficult to accurately assess aptitude that is tailored to the characteristics of the test-taker.

Conventionally, in building a database for an academic aptitude assessment, there has been an inconvenience in that a department-specific database had to be manually built in a manner where relevant experts or the like directly solve the questions. This became a cause of delaying the construction of the assessment system and lowering the assessment accuracy.

In view of this, the present disclosure aims to realize the object of solving the above-described problems through a solution as described below.

According to embodiments of the present disclosure, a method for assessing academic department aptitude performed by an electronic device may comprise generating a department-specific persona language model by fine-tuning an artificial intelligence language model with department-specific profile data, generating department-specific standard response data for test questions using the department-specific persona language model, presenting a portion of the test questions to a terminal and receiving a response to the portion from the terminal, estimating, based on the received response, a response to test questions not presented to the terminal, and providing an academic department recommendation result based on the received response and the estimated response.

In an embodiment, the generating of the department-specific standard response data may comprise retrieving, using Retrieval-Augmented Generation (RAG) technology, information most similar to the test questions from the department-specific profile data based on cosine similarity, generating, by the department-specific persona language model, a response to the test questions based on the information, and generating the department-specific standard response data based on the generated response.

In an embodiment, the generating of the department-specific persona language model may comprise preprocessing the department-specific profile data into a form of question-answer pairs, and fine-tuning the artificial intelligence language model with the preprocessed data.

In an embodiment, the presenting of the portion of the test questions and the receiving of the response to the portion may comprise selectively presenting test questions for each round.

In an embodiment, the selectively presenting test questions for each round may comprise presenting, based on a response to test questions of a first round, test questions for a second round using autoencoder technology, the second round being a round subsequent to the first round.

In an embodiment, the presenting of the test questions for the second round may comprise estimating, based on the response to the test questions of the first round, a response to a portion of test questions not presented in the first round, comparing the response to the test questions of the first round and the estimated response to the portion of the test questions not presented in the first round with the department-specific standard response data based on cosine similarity, and presenting, in the second round, test questions corresponding to top n departments with high response similarity based on a result of the comparison.

In an embodiment, the selectively presenting test questions for each round may further comprise presenting, based on a response to test questions of at least one of the first or second rounds, test questions for a third round using autoencoder technology, the third round being a round subsequent to the second round.

In an embodiment, the providing of the academic department recommendation result may comprise providing information regarding top m departments with high response similarity by comparing with the department-specific standard response data based on cosine similarity.

According to embodiments of the present disclosure, an electronic device comprises one or more processors, and one or more memories storing at least one instruction executable by the one or more processors, wherein the one or more processors, by executing the at least one instruction, may be configured to generate a department-specific persona language model by fine-tuning an artificial intelligence language model with department-specific profile data, generate department-specific standard response data for test questions using the department-specific persona language model, present a portion of the test questions to a terminal and receive a response to the portion from the terminal, estimate, based on the received response, a response to test questions not presented to the terminal, and provide an academic department recommendation result based on the received response and the estimated response.

According to embodiments of the present disclosure, a non-transitory computer-readable recording medium storing at least one instruction that, when executed by one or more processors, causes the one or more processors to perform operations, wherein the operations may comprise generating a department-specific persona language model by fine-tuning an artificial intelligence language model with department-specific profile data, generating department-specific standard response data for test questions using the department-specific persona language model, presenting a portion of the test questions to a terminal and receiving a response to the portion from the terminal, estimating, based on the received response, a response to test questions not presented to the terminal, and providing an academic department recommendation result based on the received response and the estimated response.

According to embodiments of the present disclosure, by generating a department-specific persona language model by fine-tuning an artificial intelligence language model for each department using department-specific profile data, and by building a database of the department-specific standard response data generated thereby, it becomes possible to easily build standard response data for hundreds of test questions. Furthermore, the suitability of the response generated by the department-specific persona model for the test questions can be increased by utilizing RAG technology, and in generating the department-specific standard response data, by using the response generated by the department-specific persona language model for the test questions instead of a human directly generating the response data, more efficient, convenient, and sophisticated department-specific standard response data can be built compared to the case where a human directly responds.

According to embodiments of the present disclosure, by utilizing autoencoder technology, as rounds proceed, it is possible to present test questions that are suitable by narrowing down the aptitude departments that match the test-taker based on the test-taker's responses, and thus, more efficient and sophisticated assessment results can be derived. For example, if it is determined through the responses of the initial rounds and the responses estimated therefrom that the test-taker shows a high correlation with the aptitude of specific departments, test questions for those departments can be presented in subsequent rounds. Furthermore, without assessing aptitude based on hundreds of fixed test questions, and without the test-taker having to respond to all of the numerous test questions, assessment results can be derived more quickly and accurately through response estimation for the unanswered test questions. Accordingly, the time the test-taker spends on the assessment can be dramatically shortened while maintaining the accuracy of the assessment.

According to embodiments of the present disclosure, by utilizing department-specific profile data, a department-specific persona language model, and the like, the academic aptitude assessment can be provided in various formats including quantitative data and qualitative descriptions, and thus, the results can be provided to the test-taker in a rich and easy-to-understand manner.

### BRIEF DESCRIPTION OF THE DRAWINGS

FIG. 1 is a diagram illustrating an environment surrounding an academic department aptitude assessment apparatus according to embodiments of the present disclosure.

FIG. 2 is a block diagram illustrating an academic department aptitude assessment apparatus according to embodiments of the present disclosure.

FIG. 3 is a flowchart illustrating a method for assessing academic department aptitude according to embodiments of the present disclosure.

FIG. 4 is a diagram for explaining a step of generating a department-specific persona language model in a method for assessing academic department aptitude according to embodiments of the present disclosure.

FIGS. 5A and 5B are diagrams illustrating an example of department-specific profile data in a method for assessing academic department aptitude according to embodiments of the present disclosure.

FIG. 6 is a flowchart illustrating a step of generating department-specific standard response data in a method for assessing academic department aptitude according to embodiments of the present disclosure.

FIGS. 7A and 7B are diagrams illustrating an example of department-specific test question data in a method for assessing academic department aptitude according to embodiments of the present disclosure.

FIG. 8 is a flowchart illustrating a step of presenting test questions and receiving responses thereto in a method for assessing academic department aptitude according to embodiments of the present disclosure.

FIGS. 9A to 9D are diagrams illustrating examples of screens displayed on a terminal in the step of presenting test questions and receiving responses thereto in a method for assessing academic department aptitude according to embodiments of the present disclosure.

FIGS. 10A to 10E are diagrams illustrating examples of an academic department recommendation result provided in the step of providing an academic department recommendation result in a method for assessing academic department aptitude according to embodiments of the present disclosure.

### DETAILED DESCRIPTION

Hereinafter, embodiments will be described in detail with reference to the accompanying drawings. However, various changes may be made to the embodiments, and the scope of rights of the patent application is not limited or restricted by these embodiments. It should be understood that all changes, equivalents, or substitutes for the embodiments are included in the scope of rights.

Specific structural or functional descriptions for the embodiments are disclosed merely for the purpose of illustration and may be embodied in various forms. Accordingly, the embodiments are not to be construed as limited to the specific forms of disclosure, and the scope of the present specification includes changes, equivalents, or substitutes included in the technical spirit.

The terminology used in the embodiments is used only for the purpose of description and should not be construed as having a limiting intention.

Unless defined otherwise, all terms used herein, including technical or scientific terms, have the same meaning as commonly understood by one of ordinary skill in the art to which the embodiments belong. It is to be understood that terms, such as those defined in commonly used dictionaries, should be interpreted as having a meaning that is consistent with their meaning in the context of the relevant art and will not be interpreted in an idealized or overly formal sense unless explicitly defined herein.

Terms such as "first" or "second" may be used to describe various components, but these terms should be interpreted only for the purpose of distinguishing one component from another. For example, a first component could be termed a second component, and, similarly, a second component could also be termed a first component.

Expressions such as "A, B, or C", "A, B, and/or C", "at least one of A, B, and C", "at least one of A, B, or C", "at least one of A, B, and/or C", "at least one selected from A, B, and C", "at least one selected from A, B, or C", "at least one selected from A, B, and/or C", and the like may mean each or all possible combinations thereof. For example, "at least one of A or B" may refer to all of at least one A, at least one B, and at least one A and at least one B.

When a component is referred to as being "connected" to another component, it should be understood that it can be directly connected or coupled to the other component, but intervening components may also be present.

A singular expression includes a plural expression unless the context clearly indicates otherwise. Conversely, a plural expression includes a singular expression unless the context clearly indicates otherwise. In this specification, the expression "each of a plurality of As" or "each of a plurality of As" may refer to each of all elements included in the plurality of As, or may refer to each of some elements of the plurality of As. In this specification, the expression "one or more As" may mean a set of one or more As unless the context clearly indicates otherwise.

The expression "configured to" as used in this specification may have a meaning such as "set to", "having the ability to", "modified to", "made to", "capable of", etc., depending on the context. This expression is not limited only to "specially designed in hardware", and for example, a processor configured to perform a specific operation may mean a general-purpose processor that can perform that operation through software execution, or a special-purpose computer structured through programming to perform that specific operation.

In this specification, terms such as "comprise" or "have" are intended to specify the presence of stated features, numbers, steps, operations, components, parts, or combinations thereof, but they should be understood as not precluding the presence or addition of one or more other features, numbers, steps, operations, components, parts, or combinations thereof.

In addition, in the description with reference to the accompanying drawings, the same components are given the same reference numerals regardless of the drawing numbers, and redundant descriptions thereof will be omitted. However, the omission of such a description is not intended to mean that the corresponding component is not included in a particular embodiment. In describing the embodiments, when it is determined that a detailed description of related known art may unnecessarily obscure the gist of the embodiment, the detailed description thereof is omitted.

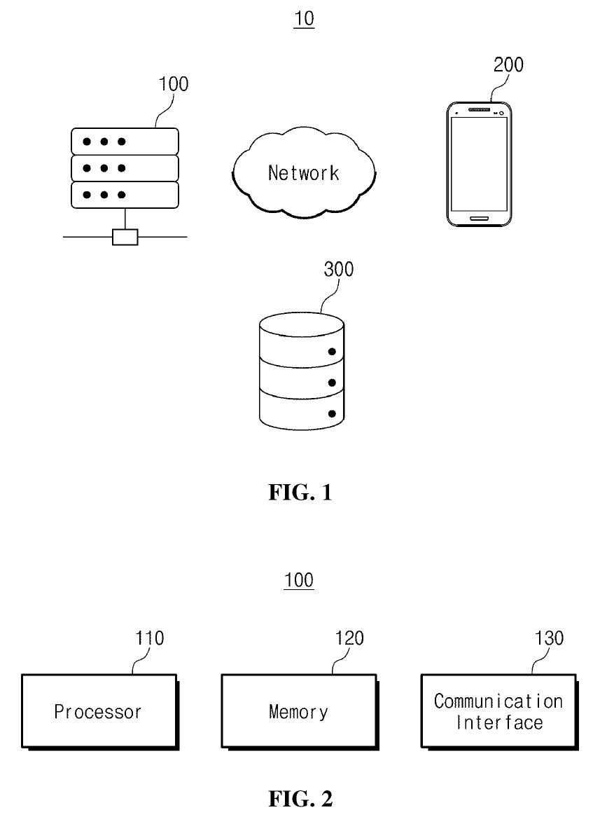

FIG. 1 is a diagram illustrating an environment surrounding an academic department aptitude assessment apparatus according to embodiments of the present disclosure.

Referring to FIG. 1, an environment 10 surrounding an academic department aptitude assessment apparatus according to embodiments of the present disclosure may include a server 100, a terminal 200, and a database 300. The server 100, the terminal 200, and the database 300 may communicate with each other through a wired or wireless network. A method for assessing academic department aptitude according to embodiments of the present disclosure may be performed by the interaction of the server 100, the terminal 200, and the database 300.

The server 100 may be an academic department aptitude assessment apparatus according to embodiments of the present disclosure. The server 100 may include various types of servers. For example, the server 100 may include various types of servers such as a centralized server, a cloud server, a distributed server, a virtual environment server, an edge server, a multi-tenant server, or a combination thereof, and each server may be implemented physically or logically. In addition, the server 100 may implement a dedicated server optimized for a specific function, a general-purpose server, or an integrated system thereof. However, this is only an example, and the present disclosure is not limited thereto.

The terminal 200 may be a device on which a test-taker performs an academic department aptitude assessment. The terminal 200 may include various types of terminals. For example, the terminal 200 may include a smartphone, a Tablet Computer, a Personal Computer (PC), a Mobile Phone, a Personal Digital Assistant (PDA), a Wearable Device, etc., but the present disclosure is not limited thereto.

The database 300 may be a hardware or software space that stores various data necessary for the academic department aptitude assessment. The database 300 may be located inside or outside an electronic device, and may be connected to the server 100 and/or the terminal 200 through a network.

The network may include a wired communication network or a wireless communication network. For example, the wired communication network may include a communication network according to a method such as Universal Serial Bus (USB), High Definition Multimedia Interface (HDMI), etc., and the wireless communication network may include a communication network according to a method such as enhanced Mobile Broadband (eMBB), Ultra Reliable Low-Latency Communications (URLLC), Massive Machine Type Communications (MMTC), Long-Term Evolution (LTE), Global System for Mobile communications (GSM), Code Division Multiple Access (CDMA), Wideband CDMA (WCDMA), Wireless Broadband (WiBro), Wireless Fidelity (WiFi), Bluetooth, Near Field Communication (NFC), Global Positioning System (GPS), etc., but the present disclosure is not limited thereto.

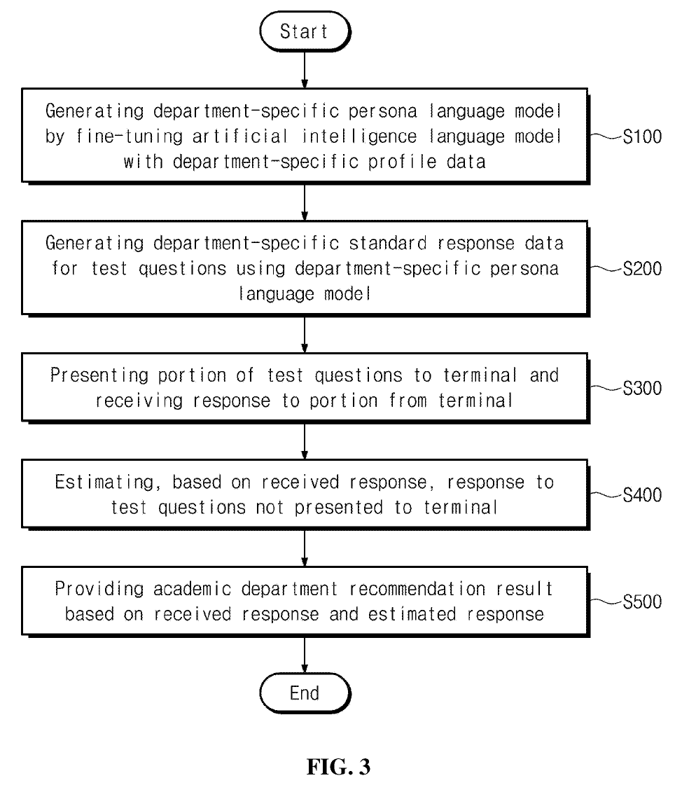

FIG. 2 is a block diagram illustrating an academic department aptitude assessment apparatus according to embodiments of the present disclosure.

Referring to FIGS. 1 and 2, an academic department aptitude assessment apparatus according to embodiments of the present disclosure is an electronic device 100 and includes a processor 110, a memory 120, and a communication interface 130. At least one of the components of the electronic device 100 may be omitted, another component may be added to the electronic device 100, or additionally or alternatively, some of the components may be implemented in an integrated manner, or may be implemented as a single or a plurality of entities. At least some of the components inside or outside the electronic device 100 may be connected to each other via a bus, General Purpose Input/Output (GPIO), Serial Peripheral Interface (SPI), or Mobile Industry Processor Interface (MIPI), etc., to give or receive data or signals.

The processor 110 may include one or more processors. The processor 110 may drive software (e.g., instructions, programs, etc.) to control at least one component of an electronic device connected to the processor 110. The processor 110 may read data from the memory 120 or write to the memory 120. In addition, the processor 110, by executing at least one instruction stored in the memory 120, may perform various operations such as calculation, processing, data generation, or manipulation according to embodiments of the present disclosure.

The processor 110 may include a Central Processing Unit (CPU), a Graphics Processing Unit (GPU), an Application Processor (AP), a mobile AP, a Digital Signal Processor (DSP), a Neural Processing Unit (NPU), a Microcontroller Unit (MCU), a Field-Programmable Gate Array (FPGA), etc., but the present disclosure is not limited thereto.

The memory 120 may include one or more memories. The memory 120 may write various data or read data upon request from the processor 110 or the like. The memory 120 may store at least one instruction to be executed by the processor 110.

The memory 120 may include Dynamic random access memory (DRAM), Static random access memory (SRAM), Twin transistor RAM (TTRAM), MRAM, Thyristor RAM (TRAM), Zero capacitor RAM (Z-RAM), Electrically Erasable Programmable Read-Only Memory (EEPROM), Flash memory, Magnetic RAM (MRAM), Spin-Transfer Torque MRAM (STT-MRAM), Conductive bridging RAM (CBRAM), Ferroelectric RAM (FeRAM), Phase change RAM (PRAM), etc., but the present disclosure is not limited thereto.

In the present disclosure, the expression "at least one or more instructions stored in the memory 120" or "a program stored in the memory 120" may be used to refer to an operating system for controlling the resources of the electronic device 100, an application, or middleware that provides various functions to an application so that the application can utilize the resources of the electronic device 100. In an embodiment, when the processor 110 performs a specific operation, the memory 120 may store instructions that are executed by the processor 110 and correspond to the specific operation.

The communication interface 130 may include one or more communication circuits. The communication interface 130 may perform wired communication or wireless communication between the electronic device 100 and an external device (e.g., the terminal 200 or a device not shown).

The communication interface 130 may perform wired communication according to a method such as the above-described USB, HDMI, etc., or perform wireless communication according to a method such as eMBB, URLLC, MMTC, etc., but the present disclosure is not limited thereto.

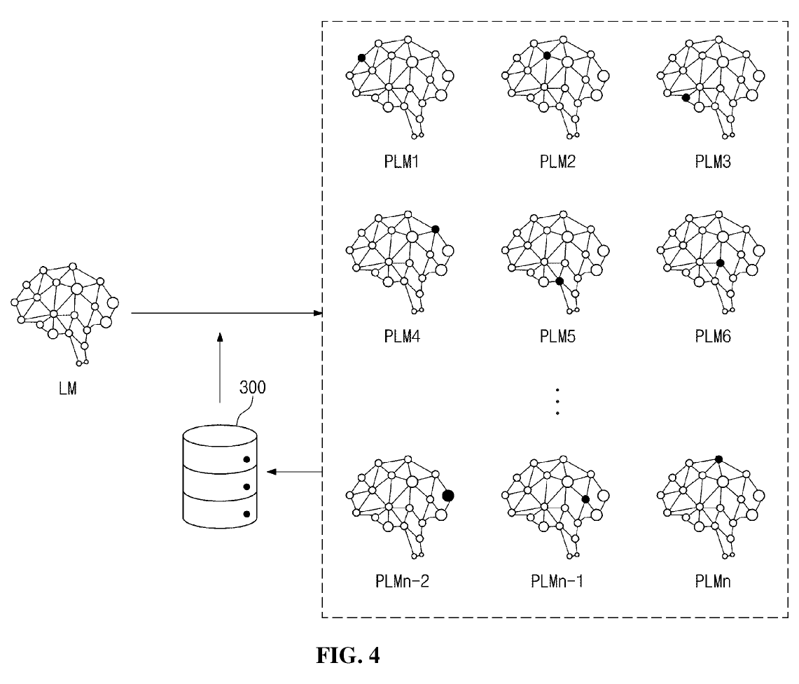

FIG. 3 is a flowchart illustrating a method for assessing academic department aptitude according to embodiments of the present disclosure.

Referring to FIGS. 1 to 3, a method for assessing academic department aptitude according to embodiments of the present disclosure is performed by an electronic device 100 and comprises a step S100 of generating a department-specific persona language model by fine-tuning an artificial intelligence language model with department-specific profile data, a step S200 of generating department-specific standard response data for test questions using the department-specific persona language model, a step S300 of presenting a portion of the test questions to a terminal and receiving a response to the portion from the terminal, a step S400 of estimating, based on the received response, a response to test questions not presented to the terminal, and a step S500 of providing an academic department recommendation result based on the received response and the estimated response.

Hereinafter, the method for assessing academic department aptitude according to embodiments of the present disclosure will be described in detail with reference to FIGS. 4 to 10.

FIG. 4 is a diagram for explaining a step of generating a department-specific persona language model in a method for assessing academic department aptitude according to embodiments of the present disclosure.

Referring to FIGS. 1 to 4, the method for assessing academic department aptitude according to embodiments of the present disclosure comprises a step S100 of generating a department-specific persona language model by fine-tuning an artificial intelligence language model with department-specific profile data. That is, in step S100, department-specific persona language models (PLM1 ~ PLMn) may be generated by fine-tuning an artificial intelligence language model (LM) with department-specific profile data on a database 300.

The artificial intelligence language model (LM) is a deep learning model that learns based on large-scale text data to understand and generate human language. The artificial intelligence language model (LM) plays a key role in the field of Natural Language Processing (NLP) and can learn large-scale text data to grasp the patterns, meanings, and contexts of words and sentences and generate new text or perform various language-related tasks. Based on the learned data, it can represent words and sentences in vector form to be used for understanding and processing text. It can accurately grasp the meaning of words and sentences by analyzing the preceding and succeeding context of a given text, and can resolve ambiguous expressions or polysemous meanings to understand the overall context of the text. Based on the learned content, it can generate new text and can generate natural and coherent text in various tasks such as translation, summarization, question answering, and dialogue. It can generate various forms of text such as novels, poems, articles, and reports, translate text into other languages, summarize long text into short text, provide answers to questions, converse naturally with people, analyze emotions contained in text, and classify text by topic. Recently, more advanced artificial intelligence language models based on deep learning architectures such as Transformer, GPT, and BERT are emerging. These models can better understand longer text, answer complex questions more accurately, and generate more natural text compared to previous models.

In the database 300, there may exist department-specific profile data. The department-specific profile data may be profile data for each of various academic departments. The department-specific profile data may be built into a database by collecting pre-existing data regarding various academic departments or by collecting it through consultation with department-related experts and the like. That is, the department-specific profile data may be stored in the database 300 in advance.

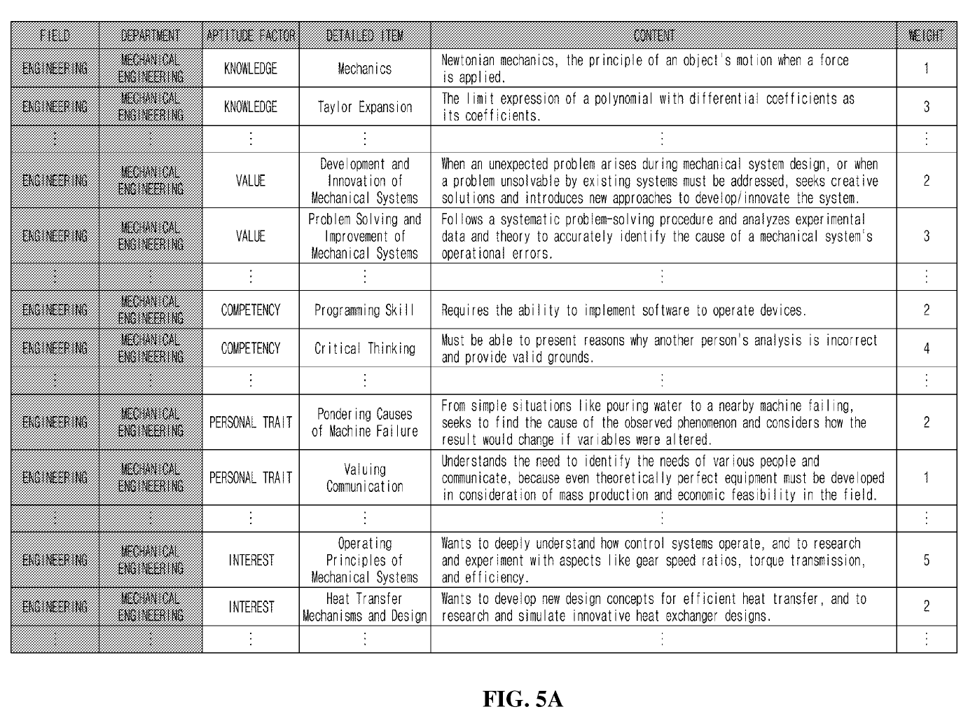

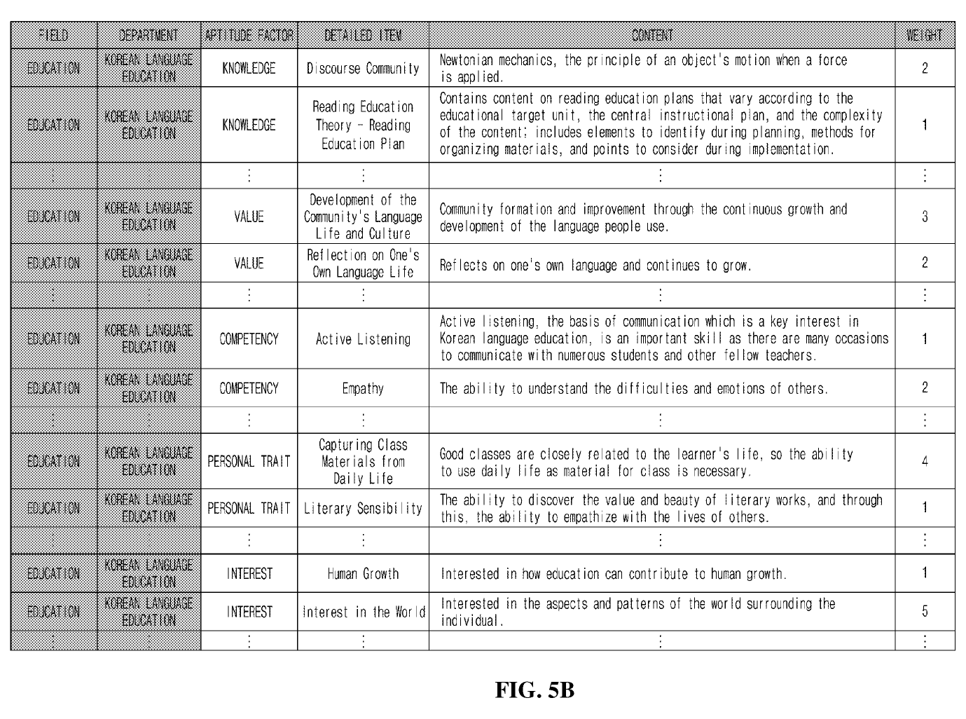

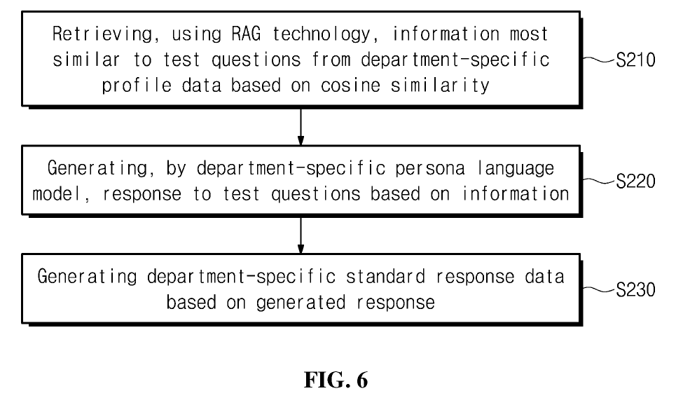

FIGS. 5A and 5B are diagrams illustrating an example of department-specific profile data in a method for assessing academic department aptitude according to embodiments of the present disclosure.

Specifically, FIG. 5A is profile data regarding the "Mechanical Engineering" department of the "Engineering" field, and FIG. 5B is profile data regarding the "Korean Language Education" department of the "Education" field.

Referring to FIGS. 5A and 5B, fields such as "Field", "Department", "Aptitude Factor", "Detailed Item", "Content", and "Weight" may be assigned to the profile data of a department. "Field" is a group of departments similar to the corresponding department and may be classified into "Engineering", "Education", "Humanities", "Social Sciences", "Law", "Natural Sciences", etc. "Department" is the name of the department and may be classified as "Mechanical Engineering", "Korean Language Education", etc. "Aptitude Factor" is a factor that serves as a standard in determining academic department aptitude and may be classified into, for example, "Knowledge", "Value", "Competency", "Personal Trait", "Interest", etc. The "Aptitude Factor" may be associated with test questions to be described later. "Detailed Item" is a sub-concept of "Aptitude Factor" and may indicate the type or kind of the corresponding data. "Content" may be the specific content of the corresponding data. "Weight" is numerical data and may indicate the importance of the corresponding data in the entire profile data of the department, and may not be an essential field. However, the above-described fields of the profile data are only examples, and the present disclosure is not limited thereto.

Referring back to FIGS. 1 to 5, department-specific persona language models (PLM1 ~ PLMn) can be generated by fine-tuning the artificial intelligence language model (LM) with department-specific profile data.

Fine-tuning is a process of finely adjusting a pre-trained artificial intelligence model to a specific task. It involves taking a model that has already been trained on a large amount of data and has general knowledge, and additionally training it with data from a specific field. Through fine-tuning, the model can improve its performance on a specific task by learning the features of new data while retaining existing knowledge. Fine-tuning can be widely used in various artificial intelligence fields such as natural language processing, computer vision, and speech recognition.

Step S100 may comprise a step of preprocessing the department-specific profile data into a form of question-answer pairs and a step of fine-tuning the artificial intelligence language model with the preprocessed data. That is, in fine-tuning, the fine-tuning may be performed by inputting the department-specific profile data in the form of question-answer pairs. For example, when data such as "design ability", "problem-solving ability", and "mathematical thinking" exist as data regarding the core competencies of the Mechanical Engineering department, the fine-tuning may be performed by converting this into the form of "Question: What are the important core competencies in the Mechanical Engineering department?" and "Answer: The core competencies of the Mechanical Engineering department include design ability, problem-solving ability, and mathematical thinking." and inputting it.

The department-specific persona language models (PLM1 ~ PLMn) are models obtained by fine-tuning the artificial intelligence language model (LM) with the profile data of each department, and may be language models having the ideal or typical characteristics of the corresponding department. Each of the persona language models (PLM1 ~ PLMn) may correspond to a specific academic department. In this case, n may be the number of departments for which profile data is built in the database 300. For example, a persona language model (PLM1) for the "Mechanical Engineering" department can be generated by fine-tuning the artificial intelligence language model (LM) with the profile data of the "Mechanical Engineering" department as in FIG. 5A. Alternatively, a persona language model (PLM2) for the "Korean Language Education" department can be generated by fine-tuning the artificial intelligence language model (LM) with the profile data of the "Korean Language Education" department as in FIG. 5B. The department-specific persona language models (PLM1 ~ PLMn) generated in this way may be stored in the database 300.

According to the above description, in the embodiments of the present disclosure, by generating a department-specific persona language model by fine-tuning an artificial intelligence language model for each department using pre-existing department-specific profile data, and by building a database of the department-specific standard response data generated thereby, it becomes possible to easily build standard response data for hundreds of test questions.

FIG. 6 is a flowchart illustrating a step of generating department-specific standard response data in a method for assessing academic department aptitude according to embodiments of the present disclosure.

Referring to FIGS. 1 to 3 and 6, the method for assessing academic department aptitude according to embodiments of the present disclosure comprises a step S200 of generating department-specific standard response data for test questions using the department-specific persona language model. Step S200 may comprise a step S210 of retrieving, using RAG technology, information most similar to the test questions from the department-specific profile data based on cosine similarity, a step S220 of generating, by the department-specific persona language model, a response to the test questions based on the information, and a step S230 of generating the department-specific standard response data based on the generated response.

In the database 300, there may exist department-specific test question data. The department-specific test question data may be test question data for each of various academic departments. The department-specific test question data may be prepared in advance and built into a database. That is, the department-specific test question data may be stored in the database 300 in advance.

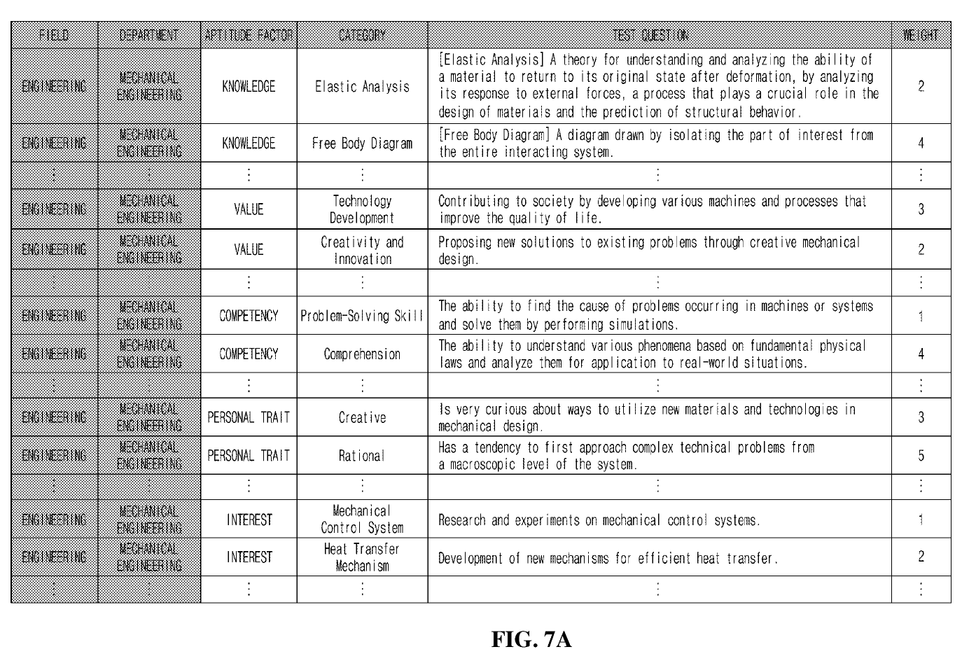

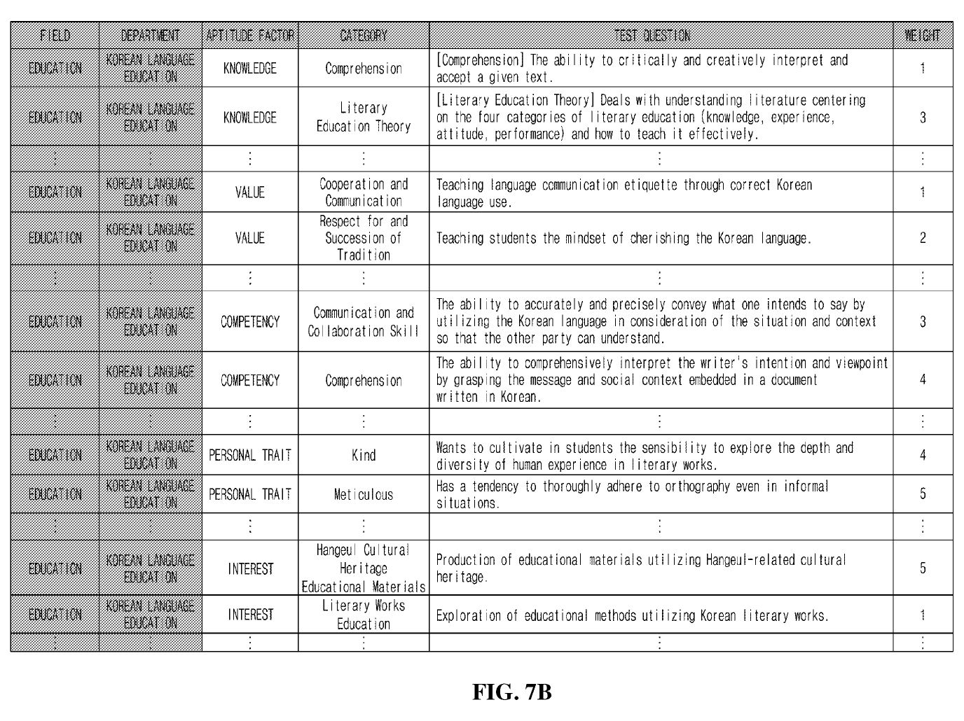

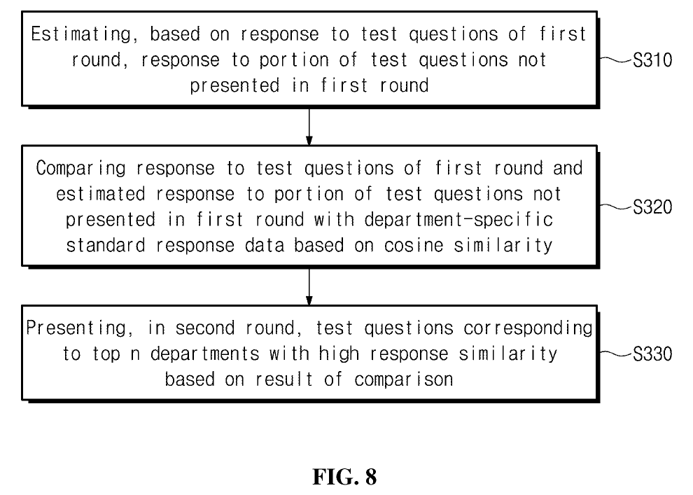

FIGS. 7A and 7B are diagrams illustrating an example of department-specific test question data in a method for assessing academic department aptitude according to embodiments of the present disclosure.

Specifically, FIG. 7A is a test question regarding the "Mechanical Engineering" department of the "Engineering" field, and FIG. 7B is a test question regarding the "Korean Language Education" department of the "Education" field.

Referring to FIGS. 7A and 7B, fields such as "Field", "Department", "Aptitude Factor", "Category", "Test Question", and "Weight" may be assigned to the test question data. "Field" is a group of departments similar to the corresponding department and may be classified into "Engineering", "Education", "Humanities", "Social Sciences", "Law", "Natural Sciences", etc. "Department" is the name of the department and may be classified as "Mechanical Engineering", "Korean Language Education", etc. "Aptitude Factor" is a factor that serves as a standard in determining academic department aptitude and may be classified into, for example, "Knowledge", "Value", "Competency", "Personal Trait", "Interest", etc. The "Aptitude Factor" may be associated with the aforementioned department-specific profile data. "Category" may be the category of the corresponding test question. "Test Question" may be the specific content of the test question. The "Test Question" may be distinguished according to the type of test or the test-taker even within the same test question data. For example, test questions for when the test-taker is a university student or a member of the general public and test questions for when the test-taker is a high school student may exist separately. "Weight" is numerical data and may indicate the importance of the corresponding test question in the entire test question data of the department, and may not be an essential field. However, the above-described fields of the test question data are only examples, and the present disclosure is not limited thereto.

Each piece of test question data may correspond to one academic department. For example, each piece of test question data in FIG. 7A may correspond to the "Mechanical Engineering" department, and each piece of test question data in FIG. 7B may correspond to the "Korean Language Education" department.

Each piece of test question data may correspond to one aptitude factor. For example, the data in the first row of the test question data of FIG. 7A may correspond to the "Knowledge" aptitude factor, and the data in the first row of the test question data of FIG. 7B may correspond to the "Knowledge" aptitude factor.

For each academic department, a predetermined number of pieces of test question data may exist for each aptitude factor (e.g., "Knowledge", "Value", "Competency", "Personal Trait", "Interest", etc.). For example, the predetermined number may be 5.

Referring back to FIGS. 1 to 3 and 6, step S200 comprises a step S210 of retrieving, using RAG technology, information most similar to the test questions from the department-specific profile data based on cosine similarity.

Retrieval-Augmented Generation (RAG) is a technology that improves the accuracy of question answering by having an artificial intelligence language model utilize an external knowledge base. RAG technology retrieves information related to an input query through an external database or search engine, and generates a more precise response by using the retrieved information as input to the model. Through this, compared to conventional simple pre-training-based generation models, it can provide responses that reflect the latest information or expert knowledge in a specific domain. In the present disclosure, RAG technology can be utilized to retrieve information similar to test questions from department-specific profile data.

Cosine similarity is a method of measuring similarity using the angle between two vectors and is widely used in various fields such as text mining, information retrieval, and recommendation systems. The method of utilizing cosine similarity for data similarity measurement is as follows. First, the data to be compared is converted into vectors. In the case of text documents, they can be represented as vectors using the frequency of each word, and images can be represented as vectors by extracting pixel values or features. By calculating the cosine similarity using these converted vectors, the similarity between the two data can be quantified. In the present disclosure, RAG technology can be utilized to retrieve information most similar to the test questions from the department-specific profile data based on cosine similarity.

In addition, to maximize the utilization of the retrieved information, RAG technology may include a process of evaluating the similarity between the query and the retrieved documents. This similarity evaluation can be performed by applying various methods such as a Vector Space Model, Document Embedding, statistical weight-based evaluation (TF-IDF based evaluation), and deep learning-based semantic similarity evaluation (Neural Semantic Similarity). This similarity evaluation technique can contribute to selecting data with higher relevance from the retrieved information and generating an optimal response based on it.

In the present disclosure, RAG technology can be utilized to retrieve information related to test questions from department-specific profile data, and to select optimal data by evaluating the similarity between the retrieved information and the questions. Through this similarity evaluation technique, the accuracy of information retrieval and answer generation can be improved, and it can be utilized in various application fields.

Step S200 comprises a step S220 of generating, by the department-specific persona language model, a response to the test questions based on the information.

That is, in step S220, the department-specific persona language model may generate a response to the test questions based on the information retrieved in step S210. In other words, the department-specific persona language model can solve the test questions. The test questions here may be test questions for all departments. For example, the department-specific persona language model may generate a response between 1 to 7 points (1 point: Strongly disagree, 2 points: Disagree, 3 points: Somewhat disagree, 4 points: Neither agree nor disagree, 5 points: Somewhat agree, 6 points: Agree, 7 points: Strongly agree) for each of the test questions.

Referring to FIGS. 4, 6, 7A, and 7B, for example, the persona language model (PLM1) of the "Mechanical Engineering" department may generate responses to test questions for all departments, such as those in FIGS. 7A, 7B, etc. For example, the persona language model (PLM2) of the "Korean Language Education" department may generate responses to test questions for all departments, such as those in FIGS. 7A, 7B, etc.

Since the department-specific persona language model has the ideal or typical characteristics of the corresponding department, the response generated by the department-specific persona language model for a test question may be similar to the ideal or typical response of that department.

Step S200 comprises a step S230 of generating the department-specific standard response data based on the generated response.

That is, in step S230, the department-specific standard response data may be generated based on the response generated in step S220. The department-specific standard response data may be a set of responses generated by the department-specific persona language model for the test questions. For example, the standard response data for the "Mechanical Engineering" department may be a set of responses generated by the persona language model of the "Mechanical Engineering" department. The standard response data for the "Korean Language Education" department may be a set of responses generated by the persona language model of the "Korean Language Education" department. The generated department-specific standard response data may be stored in the database 300.

According to the above description, in the embodiments of the present disclosure, the suitability of the response generated by the department-specific persona model for the test questions can be increased by utilizing RAG technology, and in generating the department-specific standard response data, by using the response generated by the department-specific persona language model for the test questions instead of a human directly generating the response data, more efficient, convenient, and sophisticated department-specific standard response data can be built compared to the case where a human directly responds.

FIG. 8 is a flowchart illustrating a step of presenting test questions and receiving responses thereto in a method for assessing academic department aptitude according to embodiments of the present disclosure.

Referring to FIGS. 1 to 3 and 8, the method for assessing academic department aptitude according to embodiments of the present disclosure comprises a step S300 of presenting a portion of the test questions to a terminal and receiving a response to the portion from the terminal.

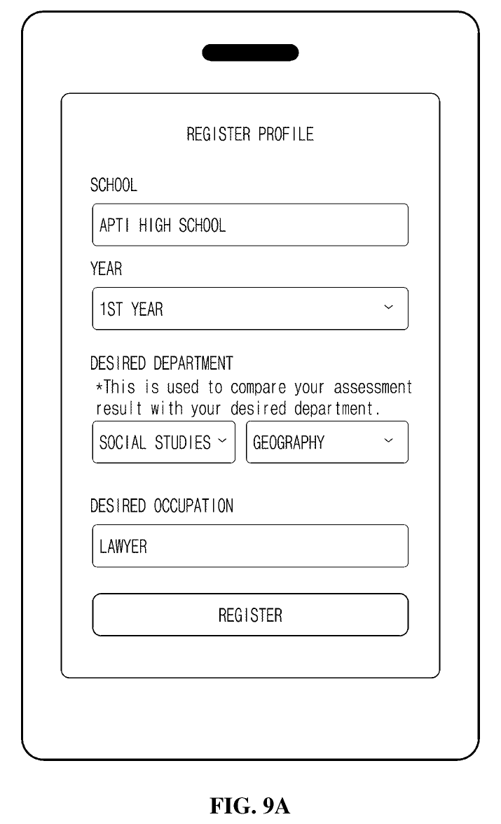

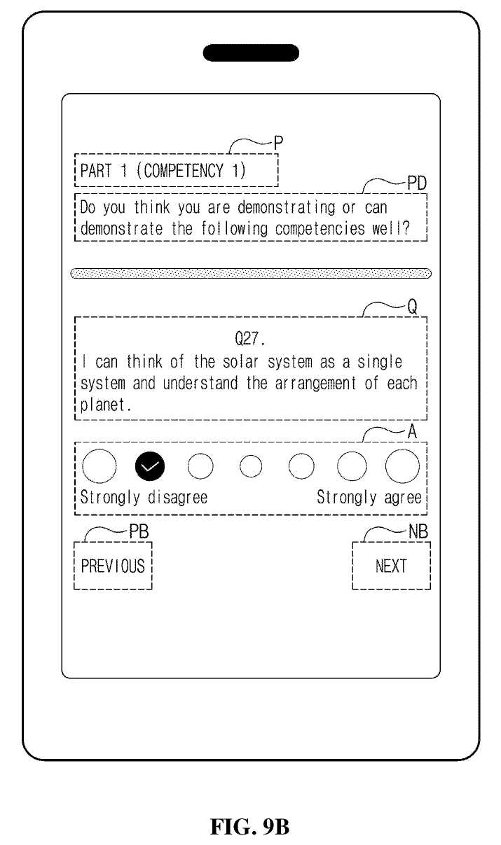

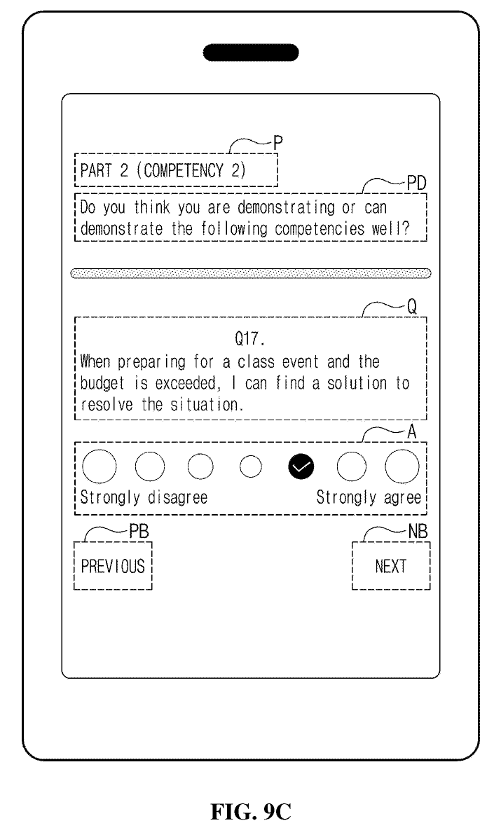

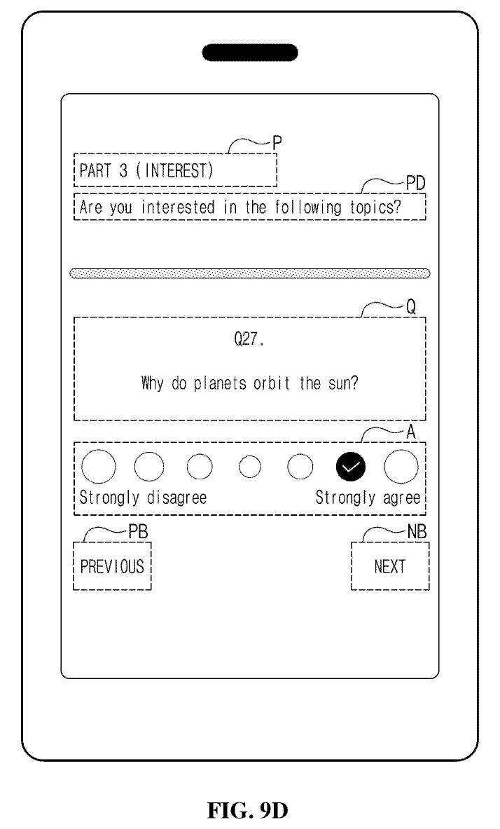

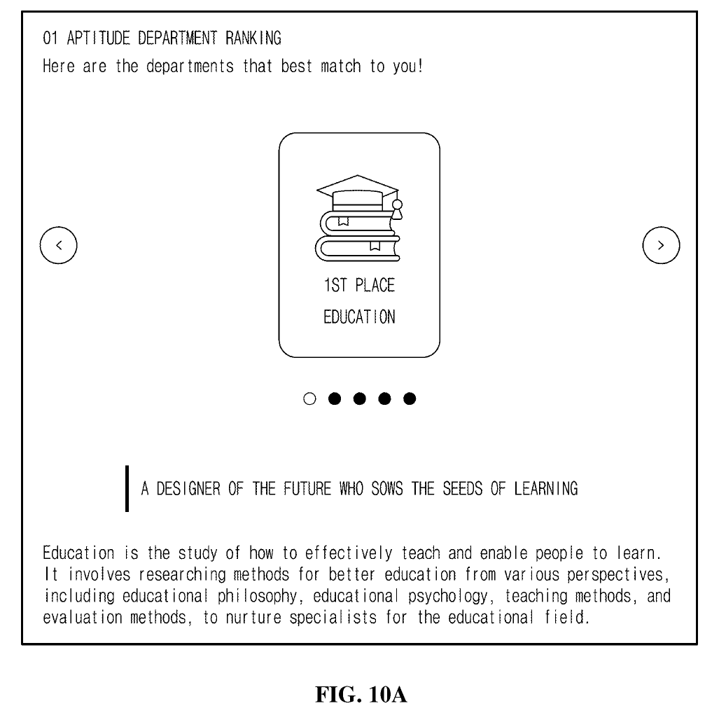

Step S300 may comprise a step of selectively presenting test questions for each round. A round may be one step in the academic department aptitude assessment in which a group of a portion of the test questions is presented. For example, the academic department aptitude assessment may consist of a plurality of rounds, and a plurality of test questions may be presented in each round. In the method for assessing academic department aptitude according to embodiments of the present disclosure, a portion of the test questions can be selected and presented to the terminal for each round. The test questions presented in each round may be test questions related to each other. For example, the test questions presented in each round may be test questions corresponding to one "Aptitude Factor". The method of presenting test questions for each round will be described in detail with reference to FIGS. 9A to 9D.

FIGS. 9A to 9D are diagrams illustrating examples of screens displayed on a terminal in the step of presenting test questions and receiving responses thereto in a method for assessing academic department aptitude according to embodiments of the present disclosure.

FIG. 9A is a diagram illustrating an example of a screen for receiving assessment information from a test-taker before presenting test questions.

Referring to FIGS. 1 and 9A, a test-taker may input assessment information through the terminal 200 before starting the assessment. For example, the assessment information may be the test-taker's school, year, desired department, desired occupation, etc. In addition, although not shown, the assessment information may include the test-taker's current department. The desired department may be presented so that the test-taker can select from among the departments existing in the department-specific profile data stored in the database 300. The desired department and desired occupation entered by the test-taker may be associated with the test questions or results presented in the assessment. That is, in the method for assessing academic department aptitude according to the present disclosure, test questions may be presented or assessment results may be provided based on the desired department and desired occupation entered by the test-taker. When the test-taker clicks or touches the "REGISTER" button, the assessment may begin.

FIGS. 9B to 9D are diagrams illustrating an example of a screen in which one test question is presented in each of the first to third rounds, respectively.

Referring to FIGS. 1 and 9B to 9D, an "Aptitude Factor" (P) corresponding to the respective round and a description thereof (PD) may be displayed on the screen. For example, on the screen of the first round in FIG. 9B, "COMPETENCY 1" (meaning the first round among the "Competency" aptitude factor) as the "Aptitude Factor" (P) and a description thereof (PD) may be displayed. On the screen of the second round in FIG. 9C, "COMPETENCY 2" (meaning the second round among the "Competency" aptitude factor) as the "Aptitude Factor" (P) and a description thereof (PD) may be displayed. On the screen of the third round in FIG. 9D, "INTEREST" as the "Aptitude Factor" (P) and a description thereof (PD) may be displayed.

A plurality of test questions may be presented in each round. For example, 27test questions may be presented in the first round. In this case, FIG. 9B may be a screen in which the "Q27" question (Q), which is the 27th question among the plurality of test questions of the first round, is presented. For example, 17 test questions may be presented in the second round. In this case, FIG. 9C may be a screen in which the "Q17" question (Q), which is the 17th question among the plurality of test questions of the second round, is presented. For example, 27test questions may be presented in the third round. In this case, FIG. 9D may be a screen in which the "Q27" question (Q), which is the 27th question among the plurality of test questions of the third round, is presented.

On the screen, a response area (A) may be displayed around the test question (Q). The response area (A) may be an area where the test-taker can input their response to the test question (Q). For example, the response area (A) may be configured so that the test-taker can input a response in a 7-point multiple-choice format. For example, the 7-point multiple-choice input may be an input that divides the degree between "Strongly disagree" and "Strongly agree" into 7 levels. The test-taker may input their response by clicking or touching one of the plurality of options in the response area (A).

When the test-taker finishes responding to all the test questions of one round, a "PREVIOUS" button (PB) and a "NEXT" button (NB) may be generated at the bottom of the screen. When the test-taker clicks or touches the "NEXT" button (NB), the test questions of the next round may be presented. When the test-taker clicks or touches the "PREVIOUS" button (PB), the test questions of the corresponding round may be presented again from the beginning.

In the method for assessing academic department aptitude according to embodiments of the present disclosure, the questions of the first round may be questions related to the test-taker's current department, desired department, or desired occupation. That is, based on the department-specific profile data and test question data, test questions regarding the current department, desired department, or desired occupation entered by the test-taker may be presented.

Referring back to FIGS. 1 to 3 and 8, the step of selectively presenting test questions for each round may comprise a step of presenting test questions for a second round using autoencoder technology based on a response to test questions of a first round. Here, the second round may be a round subsequent to the first round.

An autoencoder is a type of artificial neural network, an architecture used to extract latent features of data through a learning process of converting input data into a compressed representation and then restoring it back to its original form. Specifically, in an autoencoder, first, the input data is received through an encoder and converted into a compressed form of a latent variable. In this process, important features of the data are extracted and unnecessary information is removed. Then, the compressed latent variable is restored back to the original input data form through a decoder. The autoencoder is trained in a way that minimizes the error between the input data and the reconstructed data. Through this learning process, the autoencoder can effectively learn the complex structure of data and extract its latent features. A method of presenting test questions for a second round based on a response to test questions of a first round using autoencoder technology in the method for assessing academic department aptitude according to embodiments of the present disclosure will be described in detail below.

Specifically, step S300 may comprise a step S310 of estimating, based on the response to the test questions of the first round, a response to a portion of test questions not presented in the first round, a step S320 of comparing the response to the test questions of the first round and the estimated response to a portion of the test questions not presented in the first round with the department-specific standard response data based on cosine similarity, and a step S330 of presenting, in the second round, test questions corresponding to top n departments with high response similarity based on a result of the comparison.

In step S310, when the test-taker finishes responding to the test questions of the first round (i.e., a portion of the test questions of all rounds), a response to a portion of the test questions not presented in the first round may be estimated using autoencoder technology based on the test-taker's responses. For example, the portion of the test questions not presented in the first round (i.e., the test questions subject to response estimation) may be test questions similar to the test questions of the first round. Specifically, a response to questions within a corresponding aptitude factor can be estimated based on the test-taker's response pattern for that aptitude factor (e.g., competency, interest, value, personal trait, knowledge) among the test questions not presented in the first round. By utilizing the response data for some questions of a specific aptitude factor, the responses to the remaining un-presented questions within the same aptitude factor can be complementarily predicted. For example, if only some questions related to the 'competency' factor were presented in the first round, responses to the un-presented questions belonging to the 'competency' factor can be automatically estimated based on the response pattern to those questions.

Even for a test question not presented in the first round, it is possible to estimate how the test-taker would respond to that question by considering the response patterns of the department-specific personas. That is, without having to present all similar questions again in subsequent rounds, the assessment results can be derived by correcting the test-taker's response tendency based on existing responses and department-specific persona data.

In step S320, the response to the test questions of the first round (i.e., the test-taker's actual response to the test questions presented in the first round) and the response estimated in step S310 (i.e., the estimated response for the questions corresponding to the relevant aptitude factor among the test questions not presented in the first round) can be compared with the department-specific standard response data. The comparison may be based on cosine similarity. Here, the department-specific standard response data may be the standard response data of each department generated based on the department-specific persona language model as described above with reference to FIG. 6, etc.

Specifically, by synthesizing the response to the test questions of the first round and the estimated response to a portion of the test questions not presented in the first round, it can be determined which department's standard response data is most similar by comparing with the department-specific standard response data based on cosine similarity.

In step S330, departments with high response similarity are selected based on the comparison result in S320, and test questions corresponding to the selected departments can be presented to the terminal in the second round. For example, the top n (where n is a natural number) departments can be selected in order of high response similarity.

For example, if the "Mechanical Engineering" and "Robotics Engineering" departments are selected in order of high response similarity based on the comparison result in S320, a portion of the test questions of the "Mechanical Engineering" and "Robotics Engineering" departments can be presented in the second round by referring to the test question data.

Such steps can be repeated for each round. That is, in each round, test questions can be selected and presented through the above-described steps, based on the test-taker's response in the previous round (or at least one of all previous rounds) and the response estimated thereby (for test questions not yet presented). For example, test questions for a third round, which follows the second round, may be selected and presented using autoencoder technology based on a response to test questions of at least one of the first or second rounds. For example, test questions for a third round, which follows the second round, may be selected and presented using autoencoder technology based on the responses to the test questions of the first and second rounds. Alternatively, the test questions for the third round may be selected and presented using autoencoder technology based only on the response to the test questions of the second round.

According to the above description, in the embodiments of the present disclosure, as rounds proceed, it is possible to present test questions that are suitable by narrowing down the aptitude departments that match the test-taker based on the test-taker's responses, and thus, more efficient and sophisticated assessment results can be derived. For example, if it is determined through the responses of the initial rounds and the responses estimated therefrom that the test-taker shows a high correlation with the aptitude of specific departments, test questions for those departments can be presented in subsequent rounds. Furthermore, without assessing aptitude based on hundreds of fixed test questions, and without the test-taker having to respond to all of the numerous test questions, assessment results can be derived through response estimation.

Referring back to FIG. 3, the method for assessing academic department aptitude according to embodiments of the present disclosure comprises a step S400 of estimating, based on the received response, a response to test questions not presented to the terminal.

In step S400, based on the test-taker's responses to all the test questions presented to the terminal, responses to the un-presented test questions may be estimated. For example, the autoencoder technology described with reference to FIG. 8 may be utilized for the estimation.

According to the above description, in the embodiments of the present disclosure, without presenting all of the hundreds to thousands of test questions to the test-taker, response results can be derived by estimating responses to un-presented test questions based on the test-taker's responses to some of the test questions, and thus, the time the test-taker spends on the assessment can be dramatically shortened while maintaining the accuracy of the assessment.

The method for assessing academic department aptitude according to embodiments of the present disclosure comprises a step S500 of providing an academic department recommendation result based on the received response and the estimated response.

In step S500, an academic department recommendation result may be provided to the terminal based on the response received in step S300 and the response estimated in step S400. For example, based on the response received in step S300 and the response estimated in step S400, information regarding the top m (where m is a natural number) departments with high response similarity may be provided as the academic department recommendation result by comparing with the department-specific standard response data based on cosine similarity.

The phrasing displayed in the academic department recommendation result may be generated through an artificial intelligence language model. Specifically, the phrasing displayed in the academic department recommendation result may be generated based on the department-specific profile data and/or the department-specific persona language model.

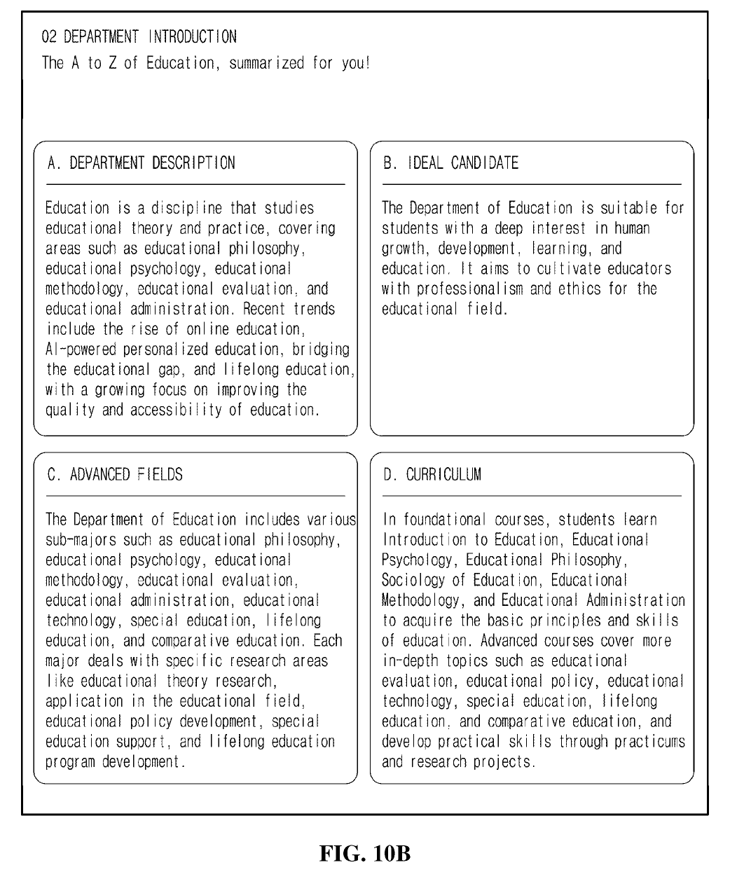

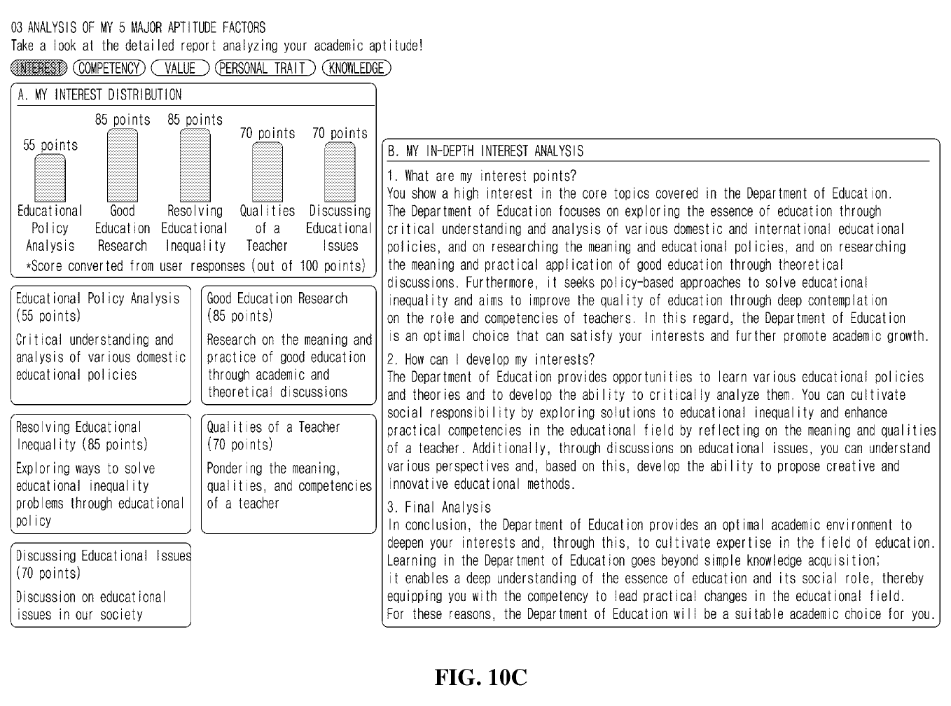

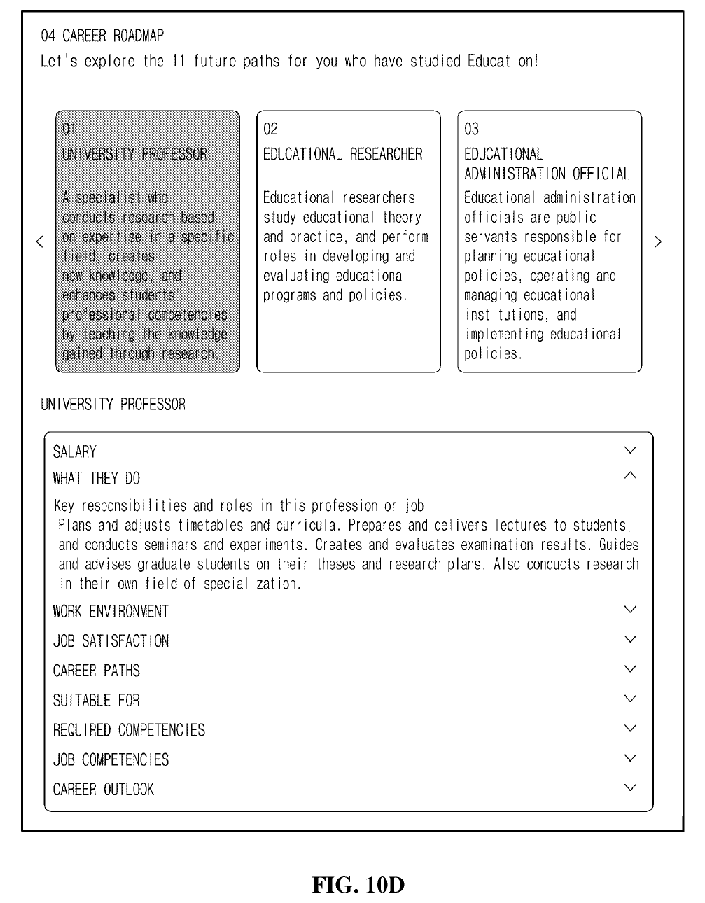

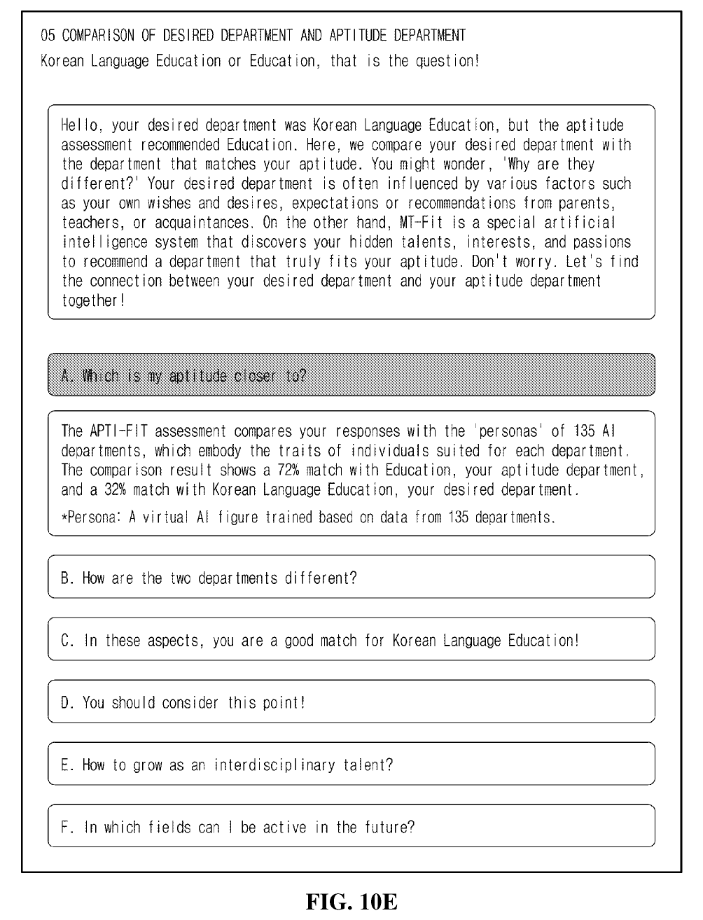

The format for providing the academic department recommendation result may be diverse, and examples thereof will be described in detail below with reference to FIGS. 10A to 10E.

FIGS. 10A to 10E are diagrams illustrating examples of an academic department recommendation result provided in the step of providing an academic department recommendation result in a method for assessing academic department aptitude according to embodiments of the present disclosure.

When the test-taker completes the academic department aptitude assessment according to embodiments of the present disclosure, academic department recommendation result screens such as those in FIGS. 10A to 10E may be displayed on the terminal.

Referring to FIG. 10A, ranking information of departments that match the test-taker's aptitude may be provided as the academic department recommendation result. The screen may display the rank, department, a picture representing the department, a description of the department, etc. The test-taker may view departments of other ranks by clicking or touching the arrow buttons located on the left and right of the screen. The phrasing displayed here may be generated based on the department-specific profile data and/or the department-specific persona language model.

Referring to FIG. 10B, an introduction to the department that matches the test-taker's aptitude may be provided as the academic department recommendation result. For example, for a department selected from the ranking information of the FIG. 10A screen, an introduction to that department may be displayed on the FIG. 10B screen. For example, a department description, ideal candidate, advanced fields, curriculum, etc., for the corresponding department may be provided. The phrasing displayed here may be generated based on the department-specific profile data and/or the department-specific persona language model.

Referring to FIG. 10C, an analysis result of the test-taker's "Aptitude Factors" may be provided as the academic department recommendation result. For example, for a department selected from the ranking information of the FIG. 10A screen, the analysis result of the test-taker's "Aptitude Factors" for that department may be displayed on the FIG. 10C screen. For example, in FIG. 10C, analysis results for each of the five major aptitude factors, "Interest", "Competency", "Value", "Personal Trait", and "Knowledge", are displayed. On a screen like that of FIG. 10C, if the test-taker clicks or touches a button corresponding to one of the five major aptitude factors, detailed results for that aptitude factor may be displayed. The detailed results may include quantified scores for each "Detailed Item" (see FIGS. 5A and 5B) or "Category" (see FIGS. 7A and 7B) of the aptitude factor. The score may indicate the test-taker's similarity or suitability for the corresponding item. In the method for assessing academic department aptitude according to embodiments of the present disclosure, since a department, aptitude factor, detailed item, category, etc., correspond to each test question, results such as the above may be provided based on the test-taker's response to the test questions. The phrasing displayed here may be generated based on the department-specific profile data and/or the department-specific persona language model.

Referring to FIG. 10D, a "Career Roadmap" may be provided as the academic department recommendation result. For example, for a department selected from the ranking information of the FIG. 10A screen, a "Career Roadmap" for that department may be displayed on the FIG. 10D screen. The "Career Roadmap" may provide information about occupations related to the department and information about those occupations. The phrasing displayed here may be generated based on the department-specific profile data and/or the department-specific persona language model.

Referring to FIG. 10E, a "Comparison of Desired Department and Aptitude Department" may be provided as the academic department recommendation result. For example, for a department selected from the ranking information of the FIG. 10A screen, a comparison result of that department and the test-taker's desired department may be displayed on the FIG. 10E screen. Specifically, a comparison result of the desired department entered by the test-taker before the assessment (see FIG. 9A) and the aptitude department derived from the assessment result can be provided. For example, as the comparison result, the test-taker's match rate (similarity or suitability) for each department, a description of each department, etc., can be provided. The phrasing displayed here may be generated based on the department-specific profile data and/or the department-specific persona language model.

According to the above description, in the embodiments of the present disclosure, by utilizing department-specific profile data, a department-specific persona language model, and the like, the academic aptitude assessment can be provided in various formats including quantitative data and qualitative descriptions, and thus, the results can be provided to the test-taker in a rich and easy-to-understand manner.

The methods according to the present disclosure may be computer-implemented methods. In the present disclosure, although each operation of the methods is illustrated and described in a predetermined order, the operations may also be performed in an order that can be arbitrarily combined according to the present disclosure, in addition to being performed sequentially. In an embodiment, at least some of the operations may be performed in parallel, iteratively, or heuristically. The present disclosure does not exclude making changes or modifications to the methods. In an embodiment, at least some of the operations may be omitted, or another operation may be added.

Various embodiments of the present disclosure may be implemented as software recorded on a machine-readable recording medium. The software may be software for implementing the various embodiments of the present disclosure described above. The software may be inferred from the various embodiments of the present disclosure by programmers in the technical field to which the present disclosure pertains. For example, the software may be a machine-readable instruction (e.g., code or code segment) or a program. A machine may be a device capable of operating according to an instruction called from a recording medium, for example, a computer. In an embodiment, the machine may be an electronic device according to an embodiment of the present disclosure. In an embodiment, a processor of the machine may execute a called instruction to cause components of the machine to perform a function corresponding to the instruction. In an embodiment, the processor may be a processor of an electronic device according to an embodiment of the present disclosure. The recording medium may mean any kind of recording medium on which data is stored and which can be read by a machine. The recording medium may include, for example, ROM, RAM, CD-ROM, magnetic tape, floppy disk, optical data storage device, etc. In an embodiment, the recording medium may be a memory. In an embodiment, the recording medium may also be implemented in a form distributed over a computer system, etc., connected by a network. The software may be distributed and stored in a computer system, etc., and executed. The recording medium may be a non-transitory recording medium. A non-transitory recording medium means a tangible medium, regardless of whether data is stored semi-permanently or temporarily, and does not include a signal that is transiently propagated.

As described above, one of ordinary skill in the art to which the present disclosure pertains will recognize that the present disclosure can be implemented in various forms without modifying its technical principles or core features. Therefore, it should be understood that the above embodiments are merely exemplary and do not limit the scope of the present disclosure. The scope of the present disclosure is defined by the claims below rather than by the detailed description, and all variations or modifications according to the meaning and scope of the claims, and the concept of equivalents, should also be interpreted as being included in the scope of the present disclosure.

The features and advantages described in the present disclosure are only partially described, and many additional features and advantages will be apparent to those skilled in the art with reference to the drawings, specification, and claims. In addition, it should be noted that the language used in the present disclosure was chosen for readability and instructional purposes and was not necessarily chosen for the purpose of limiting or describing the subject matter of the present disclosure.

The description of the above embodiments is presented for illustrative purposes, and there is no intention to thereby limit the scope of the present disclosure to the exact form. Those skilled in the art will appreciate that various modifications and variations are possible through the disclosure of the present disclosure.

Therefore, the scope of the present disclosure is not limited by the description of the invention, but is defined by the claims of this specification. Accordingly, the embodiments of the present disclosure are exemplary and do not limit the scope of the present disclosure as set forth in the claims below.

What is claimed is:

1. A method for assessing academic department aptitude, performed by an electronic device, the method comprising:
generating a department-specific persona language model by fine-tuning an artificial intelligence language model with department-specific profile data;
generating department-specific standard response data for test questions using the department-specific persona language model;
presenting a portion of the test questions to a terminal and receiving a response to the portion from the terminal;
estimating, based on the received response, a response to test questions not presented to the terminal; and
providing an academic department recommendation result based on the received response and the estimated response,
wherein the presenting of the portion of the test questions and the receiving of the response to the portion comprises selectively presenting test questions for each round.

2. The method of claim 1, wherein the generating of the department-specific standard response data comprises:
retrieving, using Retrieval-Augmented Generation (RAG) technology, information most similar to the test questions from the department-specific profile data based on cosine similarity;
generating, by the department-specific persona language model, a response to the test questions based on the information; and
generating the department-specific standard response data based on the generated response.

3. The method of claim 1, wherein the generating of the department-specific persona language model comprises:
preprocessing the department-specific profile data into a form of question-answer pairs; and
fine-tuning the artificial intelligence language model with the preprocessed data.

4. The method of claim 1, wherein the selectively presenting test questions for each round comprises:
presenting, based on a response to test questions of a first round, test questions for a second round using autoencoder technology, the second round being a round subsequent to the first round.

5. The method of claim 4, wherein the presenting of the test questions for the second round comprises:
estimating, based on the response to the test questions of the first round, a response to a portion of test questions not presented in the first round;
comparing the response to the test questions of the first round and the estimated response to the portion of the test questions not presented in the first round with the department-specific standard response data based on cosine similarity; and
presenting, in the second round, test questions corresponding to top n departments with high response similarity based on a result of the comparison.

6. The method of claim 4, wherein the selectively presenting test questions for each round further comprises:
presenting, based on a response to test questions of at least one of the first or second rounds, test questions for a third round using autoencoder technology, the third round being a round subsequent to the second round.

7. The method of claim 1, wherein the providing of the academic department recommendation result comprises:
providing information regarding top m departments with high response similarity by comparing with the department-specific standard response data based on cosine similarity.

8. An electronic device, comprising:
one or more processors; and
one or more memories storing at least one instruction executable by the one or more processors,
wherein the one or more processors are configured, by executing the at least one instruction, to:
generate a department-specific persona language model by fine-tuning an artificial intelligence language model with department-specific profile data;
generate department-specific standard response data for test questions using the department-specific persona language model;
present a portion of the test questions to a terminal and receive a response to the portion from the terminal;
estimate, based on the received response, a response to test questions not presented to the terminal; and
provide an academic department recommendation result based on the received response and the estimated response,
wherein the one or more processors are further configured to, in presenting the portion of the test questions and receiving the response to the portion, selectively present test questions for each round.

9. A non-transitory computer-readable recording medium storing at least one instruction that, when executed by one or more processors, causes the one or more processors to perform operations, the operations comprising:
generating a department-specific persona language model by fine-tuning an artificial intelligence language model with department-specific profile data;
generating department-specific standard response data for test questions using the department-specific persona language model;
presenting a portion of the test questions to a terminal and receiving a response to the portion from the terminal;
estimating, based on the received response, a response to test questions not presented to the terminal; and
providing an academic department recommendation result based on the received response and the estimated response,
wherein the presenting of the portion of the test questions and the receiving of the response to the portion comprises selectively presenting test questions for each round.
